(19) United States
(12) Patent Application Publication
(10) Pub. No.: US 2011/0227810 A1
(43) Pub. Date: Sep. 22, 2011

(54) PORTABLE COMMUNICATION DEVICE WITH SECONDARY PERIPHERAL DISPLAY

(76) Inventors: Susan MCKINNEY, Encinitas, CA (US); John Salisbury, Carisbad, CA (US); Glen Oross, San Diego, CA (US)

(21) Appl. No.: 12/728,180

(22) Filed: Mar. 19, 2010

(51) Int. Cl. G09G 5/12

(52) U.S. Cl. 345/1.3

(57) ABSTRACT

A portable communication device includes a primary display and a secondary display where the secondary display surrounds the primary display. The secondary display is translucent allowing at least some light to pass through the display to form a clear, or nearly clear, bezel around the primary display. A dot matrix system or clear LCD generates images on the secondary display and a sensing mechanism, such as a set of capacitor sensors, detects user input. User interaction with objects presented on the secondary display allows the user to manage content in the primary display.

### FIELD

This invention generally relates to portable communication devices and more particularly to a portable communication device having a secondary peripheral display.

### BACKGROUND

Many conventional portable communication devices include a visual display screen for presenting information to the user. Where the visual display screen is a touch screen, the display is used as a user input device and as an output device.

### SUMMARY

A portable communication device includes a primary display and a secondary display where the secondary display is positioned adjacent to most of the perimeter of the primary display. In one example, the secondary display is translucent allowing at least some light to pass through the display to form a clear, or nearly clear, bezel around the primary display.

### BRIEF DESCRIPTION OF THE DRAWINGS

FIG. 1A is an illustration of a perspective view of a portable communication device including a primary display and a secondary display.

FIG. 1B is an illustration of a top view of the portable communication device including a primary display and a secondary display, where the secondary display includes a dot matrix display system.

FIG. 1C is an illustration of a top view of the portable communication device including a primary display and a secondary display where the secondary display is a clear LCD display.

FIG. 1D is an illustration of a side view of the portable communication device including a primary display and a secondary display.

FIG. 2 is a block diagram of the portable communication device 100.

FIG. 3A is an illustration of a front view of the portable communication device in a standby mode.

FIG. 3B is an illustration of a front view of the portable communication device in a receive mode.

FIG. 4A, FIG. 4B, and FIG. 4C are illustrations of front views of the portable communication device in a social networking interactive mode.

FIG. 5A is an illustration of a front view of the portable communication device in a user-active interactive state.

FIG. 5B is an illustration of a side view of the portable communication device in a tilted orientation.

FIG. 6 is an illustration of a front view of the portable communication device during a rotation user input.

FIG. 7A and FIG. 7B are illustrations of a front view of the portable communication device during an application selection user input.

FIG. 7C and FIG. 7D are illustrations of a front view of the portable communication device after selection of one of the content entries of FIG. 7B.

FIG. 8 is an illustration of a front view of the portable communication device in a video mode.

FIG. 9 is an illustration of a front view of the portable communication device in a play mode.

FIG. 10A is an illustration of a front view of the portable communication device during an “all application” selection.

FIG. 10B is an illustration of a front view of the portable communication device after the “all application” selection is made.

FIG. 11A is an illustration of a front view of the portable communication device during a camera mode.

FIG. 11B is an illustration of a front view of the portable communication device during a focal point selection.

FIG. 12A is an illustration of a front view of the portable communication device during a “take picture” input in the camera mode.

FIG. 13A is an illustration of a front view of the portable communication device during a first stage of a picture cropping user input.

FIG. 13B is an illustration of a front view of the portable communication device during a second stage of a picture cropping user input.

FIG. 14A is an illustration of a front view of the portable communication device during a first stage of a picture sharing procedure.

FIG. 14B is an illustration of a front view of the portable communication device during a second stage of a picture sharing procedure.

FIG. 14C is an illustration of a front view of the portable communication device during a third stage of a picture sharing procedure mode.

FIG. 15 is an illustration of a front view of the portable communication device in the application selection mode.

### DETAILED DESCRIPTION

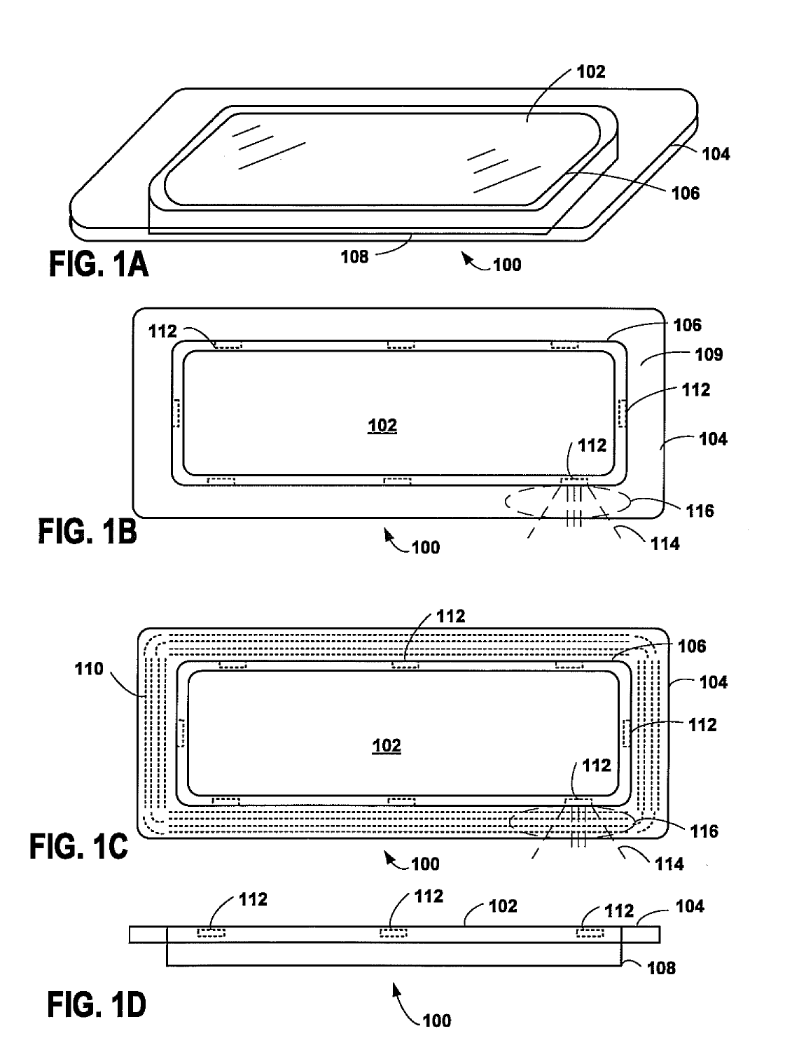

FIG. 1A is an illustration of a perspective view of a portable communication device 100 including a primary display 102 and a secondary display 104. FIG. 1B and FIG. 1C are illustrations of a top view and side view, respectively. The secondary display 104 is positioned adjacent to the primary display 102 along the perimeter 106 of the primary display 102. Both displays 102, 104 are attached to a device body 108. For the examples discussed herein, the secondary display 104 surrounds the primary display 102 and the displays 102, 104 are rectangular. Accordingly, the secondary display 104 is a non-circular ring outlining the primary display 102 in the example. The sizes and shapes of the displays 102, 104 may vary depending on the particular implementation. The primary display 102 may be any of several types of visual displays such as liquid crystal displays (LCD) screens. For the examples discussed herein, the primary display 102 is a touch screen and the secondary display 104 is a translucent touch screen. The secondary display 104 is a clear LCD display 109 in one example shown in FIG. 1B. In another example shown in FIG. 1C, the secondary display includes a dot matrix display system 110. The secondary display 104 also includes a sensing mechanism for forming the sensing portion of the touch screen display. Examples of suitable techniques for forming the input sensing mechanism include using resistive touch screen panels, surface acoustic wave (SAW) sensors, and capacitive sensing. The components are disposed within a clear rigid medium such as an acrylic layer to form the secondary display 104. An example of a suitable material for use with the secondary display includes Poly (methyl methacrylate) (PMMA). During operation, the secondary display only presents visual objects in the secondary display required for the particular function being accessed by the user. Accordingly, icons and other indicia are only visible when necessary. As discussed below, the dot matrix display system 110 or clear LCD 109 is controllable by a controller and allows for different images to be presented on the secondary display 104 based on the control signals provided by the controller.

The structure results in an appearance where the clear border formed by the secondary display 104 appears to float around the portable communication device 100. The translucent bezel formed by the secondary display 104 may include at least portions that are transparent. Although particular materials and configuration of the secondary display 104 may result in a bezel that is not transparent, the bezel is sufficiently translucent to allow at least some light to pass through the bezel. As a result, the device appears smaller since light passes through the secondary display.

A plurality of illuminating devices 112 is positioned near the secondary display 104. The illuminating devices 112 are any type of light emitting device that allows the display to be illuminated with at least two colors. For the examples herein, the illuminating devices 112 are multi-colored light emitting diodes (LEDs). In response to control signals, one or more of the illuminating devices emit a colored light 114 to cause at least a portion 116 of the secondary display to glow the color of the light. Although FIG. 1B shows eight illuminating devices, any number of devices may be used depending on the type of device and the circumstances. In some situations, illuminating devices 112 may be disposed along the entire perimeter of the secondary display 104.

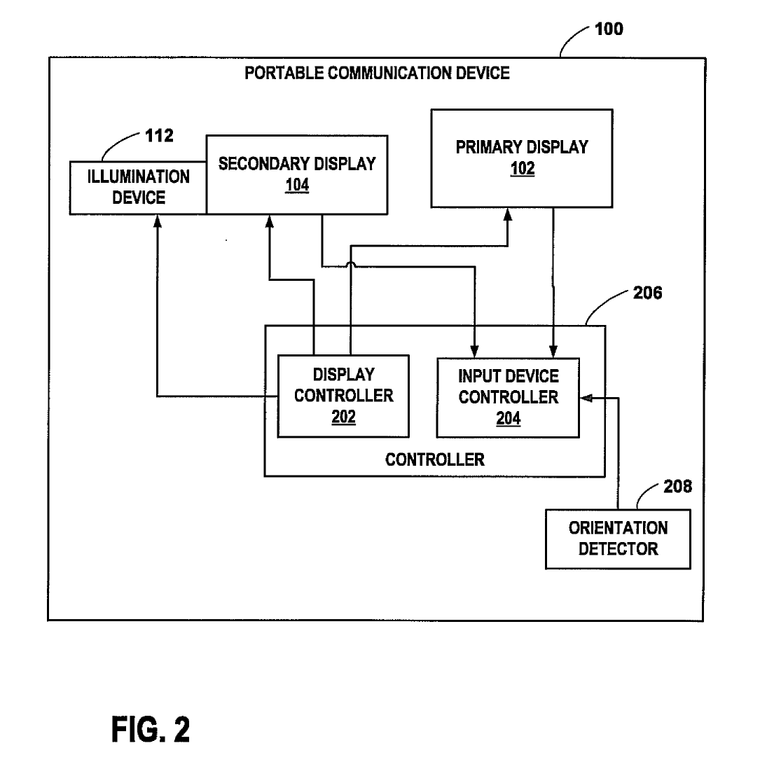

FIG. 2 is a block diagram of the portable communication device 100. A display controller 202 generates control signals to present images on the primary display 102 and the secondary display 104. An input device controller 204 receives input signals generated by input devices, such as the primary display 102 and secondary display 104, and interprets the signals as user inputs. The display controller 202 and input device controller 204 may be implemented using any combination of electronics and code. For example, the display controller 202 may include hardware driver circuits and a device driver implemented with firmware. The display controller 202 and input device controller may be implemented as part of a device controller 206 that facilitates other functions as well as the overall functionality of the portable communication device 100. The controller 206, therefore, includes a processor as well as electronics and code.

An orientation detector 208 provides information regarding the orientation of the portable communication device 100. An example of a suitable orientation detector 208 includes an accelerometer and code where movement and changes in motion are processed to determine the orientation of the portable communication device 100. The code may be implemented as part of the input device controller. As discussed below, the input device controller 204 may manage the images and input options of the displays based on the orientation information provided by the orientation detector 208.

The illumination device 112, such as one or more light emitting diodes (LEDs), illuminates the translucent secondary display 104 in response to control signals provided by the display controller 202. In the example, the illumination device 112 is responsive to the display controller 202 to illuminate the secondary display 104 with one of a plurality of colors based on the operational mode, state, and/or the application that is being executed on the portable communication device 100. In some circumstances, for example, the secondary display 104 is illuminated with a first color during a music application. A second color is used to illuminate the secondary display to indicate an incoming voice call. A third color may be used to indicate a newly received email and a forth color may indicate an incoming text message. In addition to the color, the illumination may also be varied in duration. A periodic pulsing to generate a flashing of the secondary display may be used to indicate a particular event or operational mode. Long pulses can be used to indicate another type of mode or event. In the example, the display controller is programmed by the user to associate events, operational modes, and applications with colors, illumination durations and illumination patterns. A default association may also be applied in some circumstances.

The display controller 202 generates control signals to display interface icons on the secondary display. The particular icons presented and their locations within the secondary display are based on several factors. In the examples discussed herein, the interface icons depend of the operation mode and state of the portable communication device 100. The display controller 202 manages the secondary display 104 to present the interface icons based on the circumstances and factors. The discussion below provides description of examples of the different modes of operations, actions, and images. The controller at least manages the displays 102, 104 such that a first set of interface icons are presented during a first mode and a second set of interface icons are presented during a second mode.

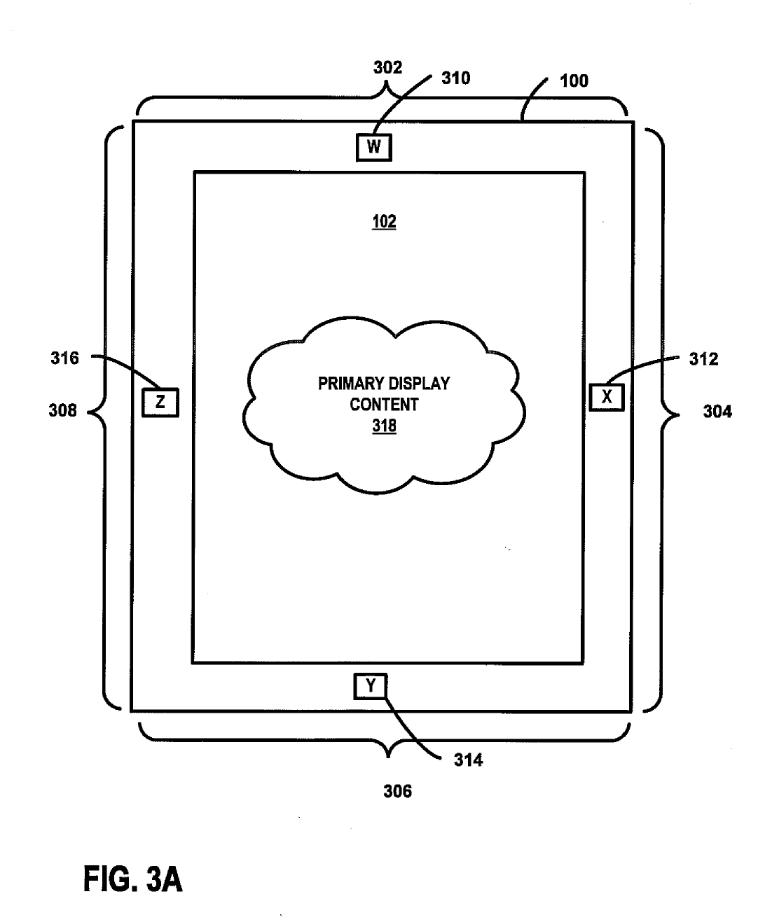

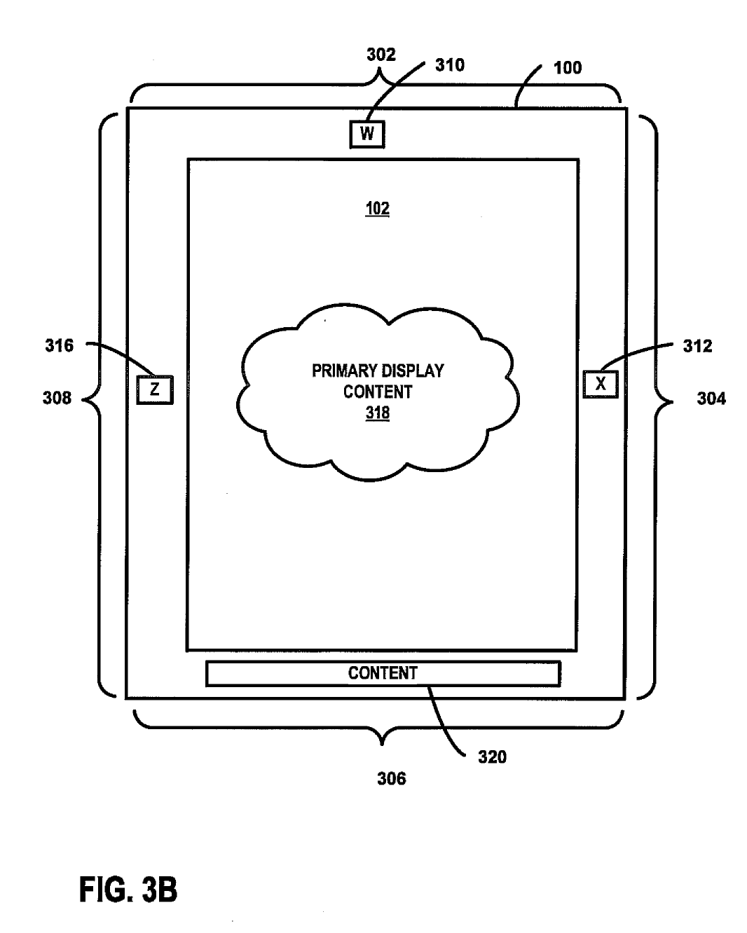

FIG. 3A is an illustration of a front view of the portable communication device 100 in a standby mode. FIG. 3B is an illustration of a front view of the portable communication device 100 in a receive mode. For the example of FIG. 3A and FIG. 3B, the secondary display 104 includes four portions that correspond to the four sides of the rectangular shaped display. The four portions include a first portion 302, a second portion 304, a third portion 306 and a fourth portion 308. Each portion is dedicated to a different application. During a standby mode, each application is represented by a visual object 310, 312, 314, 316, such as an icon, within the corresponding portion of the secondary display 104. The applications may include media content exchanges, social networking applications, messaging applications, and other applications accessible through a portable communication device. In the standby mode, the primary display content 318 presented on the primary display is not related to any of the applications represented in the secondary display.

As illustrated in FIG. 3B, newly received content 320 for represented applications is displayed in the secondary display. The newly received content 320 for an application is displayed in the secondary display portion 306 corresponding to the application receiving the content 320. The icon 314 is replaced by the received content 320 for the application represented by the icon 314. Accordingly, the primary display 102 is not disrupted by the newly received content 320. At least some of the content, however, is presented to the user through the secondary display 104. The content 320 may be static, streaming, or otherwise dynamic. The configuration may be applied and modified for application to any number of applications organized in any number of groups. The various applications and groups may be assigned by the user in preferences program mode. An example related to a social networking group of applications is discussed below.

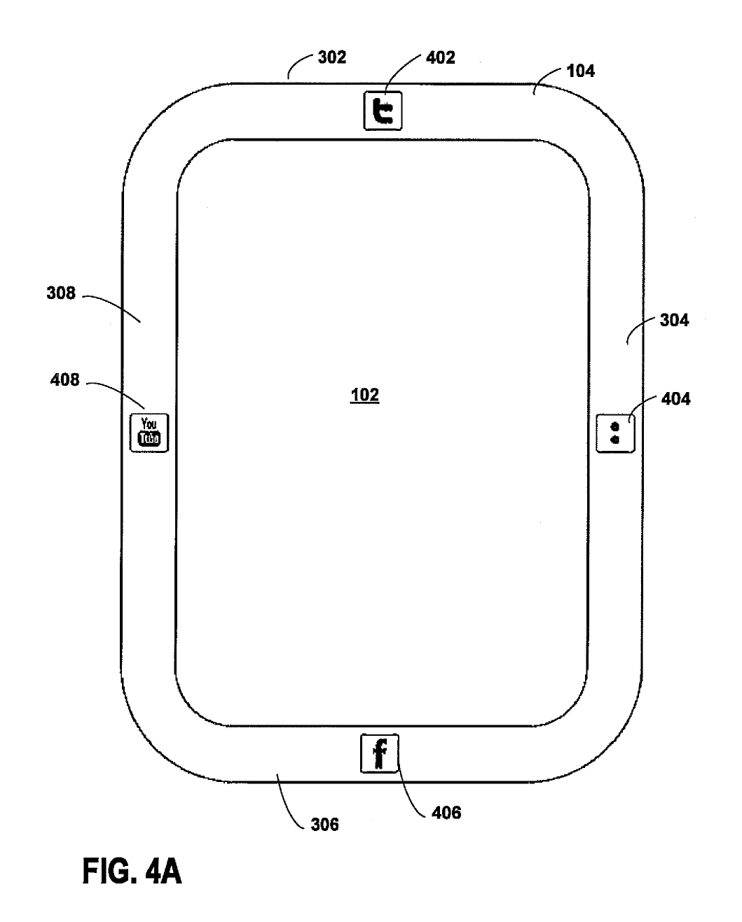

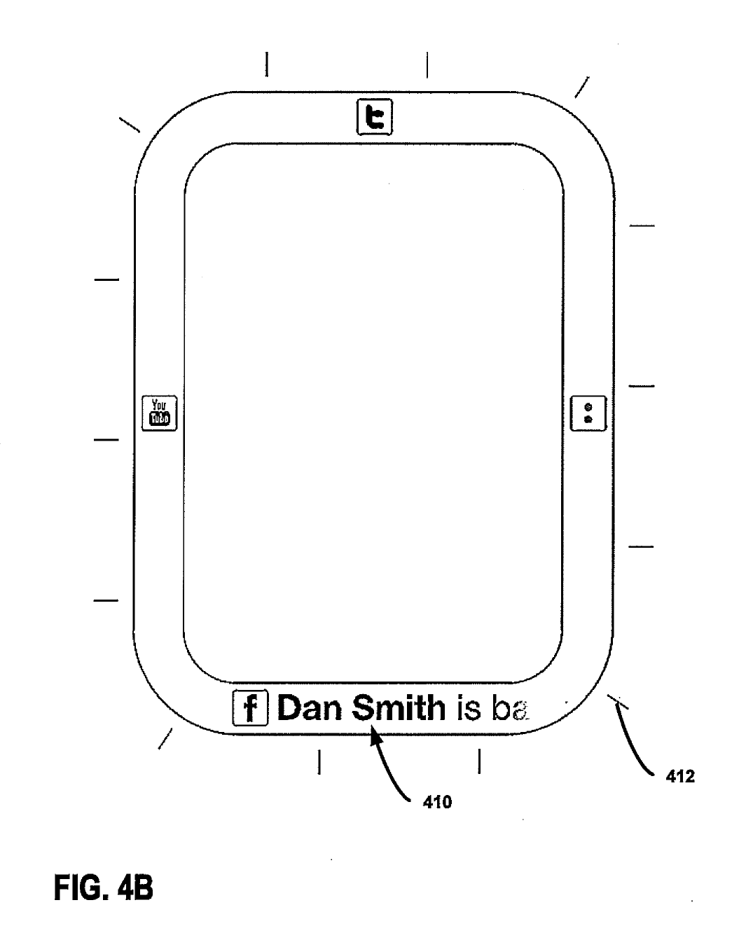

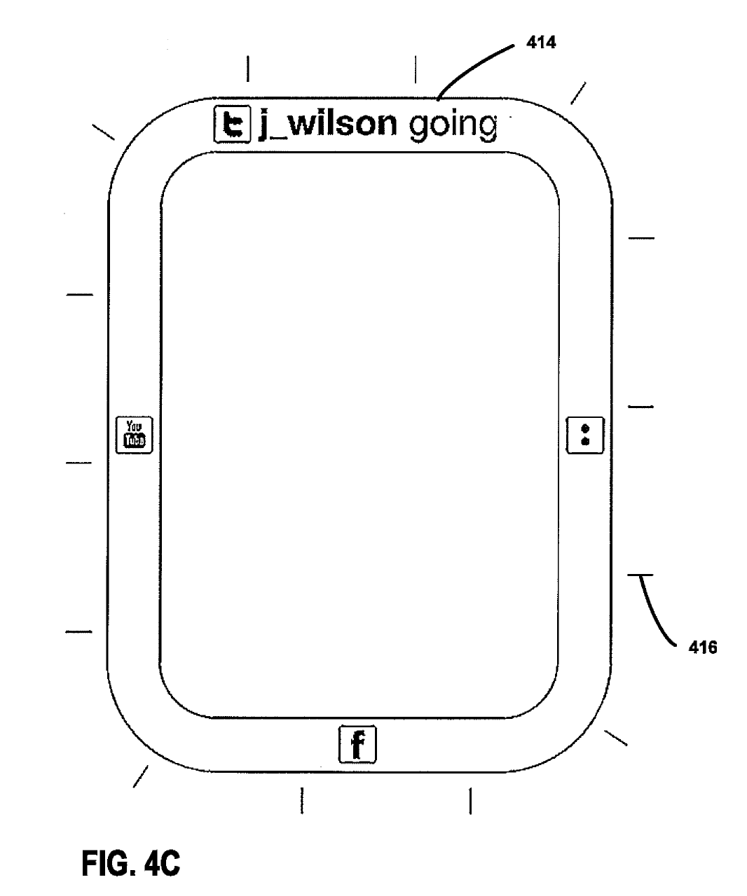

FIG. 4A, FIG. 4B, and FIG. 4C are illustrations of front views of the portable communication device in a social networking interactive mode. For the example of FIG. 4A, FIG. 4B and FIG. 4C, a twitter application is represented by a “t” icon 402, a flickr application is represented by a flickr icon 404, a facebook application is represented by an “f” icon 406, and a Youtube application is presented by a Youtube icon 408.

If new information is received for one of the applications, the newly received information is displayed in the portion of the display corresponding to the application. New text is scrolled across the portion of the secondary display corresponding to the application for which the new text was received. FIG. 4B and FIG. 4C for example, show new information being scrolled for the facebook application and the twitter application, respectively. New facebook content 410 is scrolled in the third portion 306 of the secondary display 104 and new twitter connect 414 is scrolled in the first portion 302. In some circumstances, the illumination device 112 illuminates the secondary display in accordance with an assigned color for the application receiving new information. For example, blue illumination 412 can be assigned to facebook and red illumination 416 can be assigned to twitter. When new text is scrolling for the facebook application, the secondary display 104 is illuminated blue. Continuing with the example, the secondary display 102 is illuminated red when new text is scrolling for the twitter application.

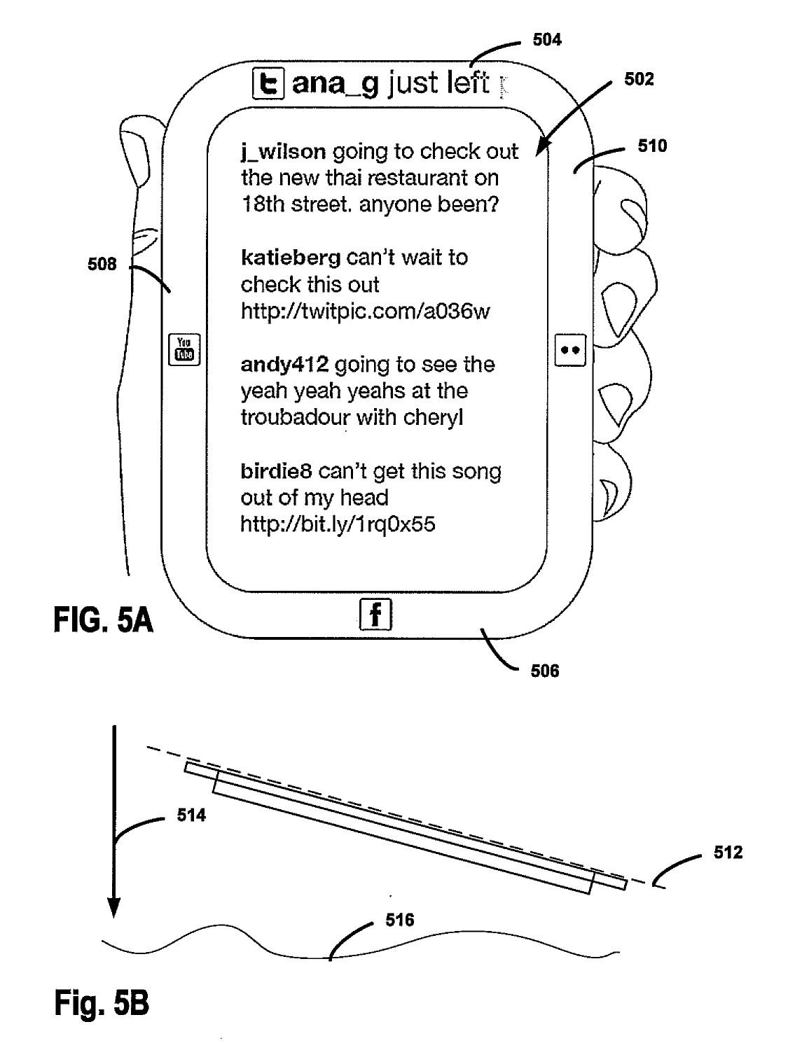

FIG. 5A is an illustration of a front view of the portable communication device 100 in a user-active interactive state. The portable communication device 100 enters the user-active interactive state when it is moved from a stable, unmoving position. The orientation detector 208 generates a control signal in response to detected movement of the portable communication device 100. The controller 206 interprets the control signal as an indication that the portable communication device 100 is being observed by the user. For example, if the portable communication device 100 is in the standby mode state while positioned on a table or desk and the user picks up the device, the controller 206 places the portable communication device 100 into the user-active interactive state. In the user-active interactive state, content 502 for the application represented in the top portion 502 of the four portions of the secondary display 104 is displayed in the primary display 102. As described with reference to FIG. 5B, the top portion 502 is the portion of the secondary display 102 that is furthest from the earth. For the circumstance illustrated in FIG. 5A, the four portions of the secondary display include the top portion 504, the bottom portion 506, the left portion 508 and the right portion 510 where the first portion 302 is the top portion 504, the second portion 304 is the right portion 510, the third portion 306 is the bottom portion 506 and the fourth portion 308 is the left portion 508.

FIG. 5B is an illustration of a side view of the portable communication device 100 in a tilted orientation. One of the secondary display portions 302, 304, 306, 308 is selected as the top portion 504 when the plane 512 of the secondary display 104 is not perpendicular to the direction 514 of gravity. The top portion 504 is the portion of the secondary display 104 that is furthest from the ground 516. The orientation detector 208 provides information to the controller 206 indicating which portion is furthest from the ground 516. In response, the controller 206 identifies that portion as the top portion 502. As described above, content 502 related to the application assigned to the top portion 504 is displayed in the primary display 102 in the user-active interactive state.

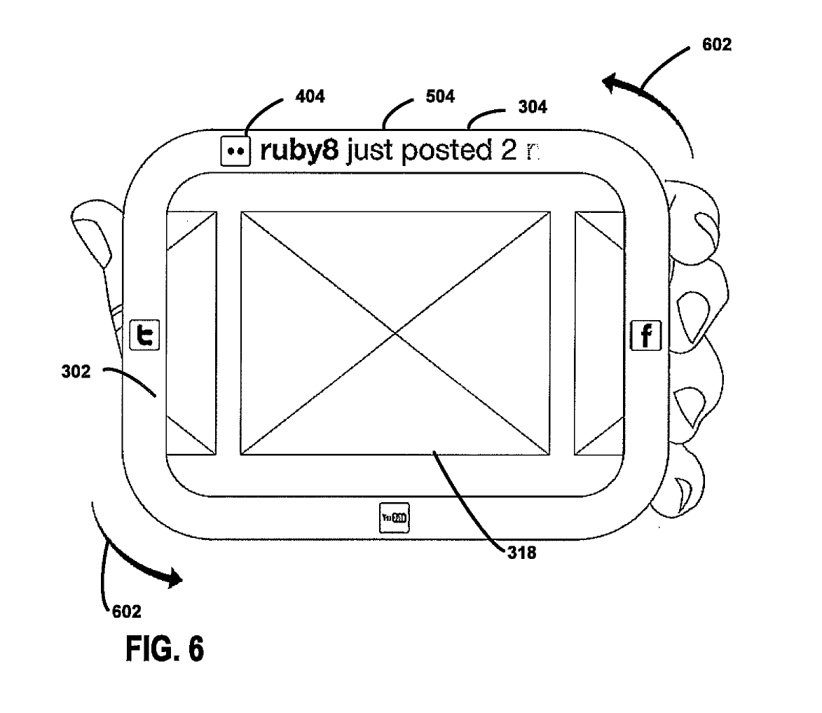

FIG. 6 is an illustration of a front view of the portable communication device during a rotation user input. The user rotates and angles the portable communication device to select a secondary display portion as the top portion. Arrows labeled 602 show the direction of the rotation. For the example, the previous position is the position illustrated in FIG. 5A. After the rotation, the second portion 304 is defined as the top portion 502. Accordingly, the portion of the display assigned to the twitter application is rotated from the top portion to the left portion 508 and the portion for the flickr application is now at the top. The controller 206 identifies the new top portion based on the signals generated by the orientation detector 208. In response, the display controller generates images on the primary display related to the application assigned to the secondary display portion that is identified as the top portion. Accordingly, the user can select the content 318 presented on the primary display 102 by rotating the portable communication device 100. For the example discussed with reference to FIG. 6, the user rates the portable communication device to place the secondary display portion 304 assigned to the flickr application and including the flickr icon 404 to be at the top. Therefore, the portable communication device 100 is positioned to place the flickr icon in the top portion 504 of the secondary display. In response, the display controller displays the flicker application content 318 in the primary display 102.

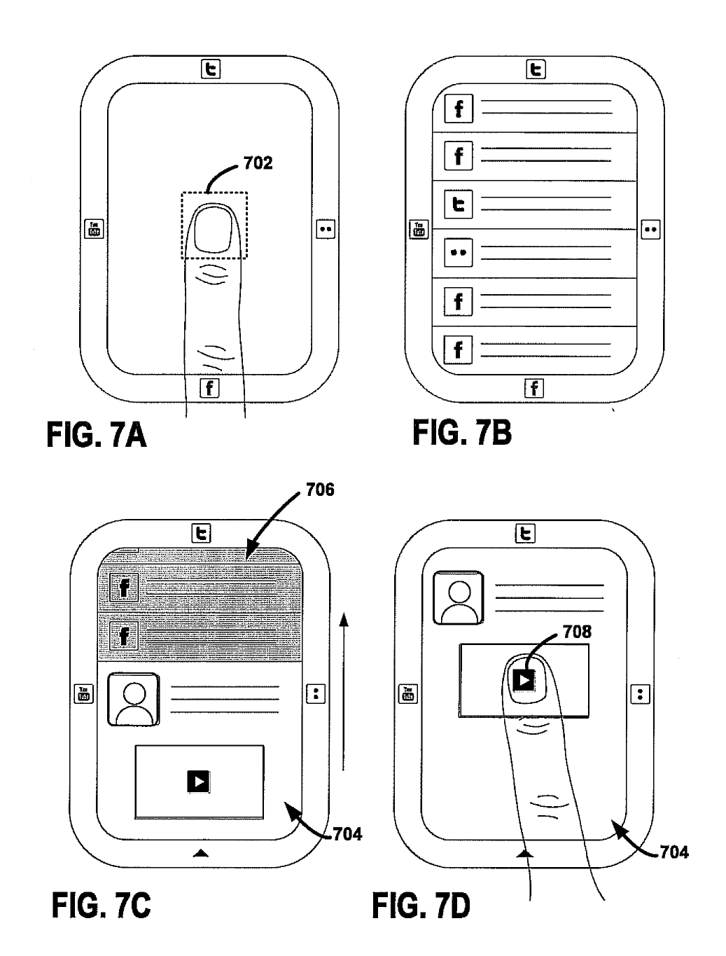

FIG. 7A and FIG. 7B are illustrations of a front view of the portable communication device during an application selection user input. To display summarized content in the primary display 102 from at least two of the applications represented in the secondary display 104, the user touches a center portion 702 of the primary display. The input device controller 204 detects the input by receiving control signals generated by the touch screen of the primary display 102. In response, the display controller 202 generates an image to display on the primary display 102 that includes available content from the pre-selected applications represented in the secondary display 104. For the example, tapping the center of the primary display 102 selects a set of applications related to social networking. Accordingly, content for the facebook, twitter and flicker applications is displayed in response to tapping the center portion 702 of the primary display 102 as shown in FIG. 7B. One of the content entries is selected by touching the primary display 102 at the location of the entry to be selected. In the example, such a selection is configured to directly access the content of the entry. In some circumstances, however, the selection provides additional information for the entry while displaying at least some of the previously displayed content entries.

FIG. 7C and FIG. 7D are illustrations of a front view of the portable communication device after selection of one of the content entries of FIG. 7B. For the example, the image provided on the primary display in FIG. 7C and FIG. 7D is in response to selection of one of the facebook entries of FIG. 7B. FIG. 7C shows the transition from the image of FIG. 7B to the image of FIG. 7D. In the example, the content 704 for the selected entry is gradually displayed and the previous image 706 is removed to give the appearance that the content is sliding in from the bottom of the display and the other entries are sliding off the display at the top. FIG. 7D shows the display with the content 704 of the selected entry. Additional content may be accessed through the screen shown in FIG. 7D. A video, for example, may be launched by tapping on the “play” icon 708.

FIG. 8 is an illustration of a front view of the portable communication device in a video mode. The secondary display 104 includes video control icons 802, 804, 806. 808 in the video mode. The user controls the video content 810 in the primary display 102 by tapping the video control icons 802, 804, 806. 808 in the secondary display 104. For the example shown in FIG. 8, the video controls include “play” 806, “stop” 802, “next” 804, and “previous” 808. Different and/or additional controls may be included in some circumstances.

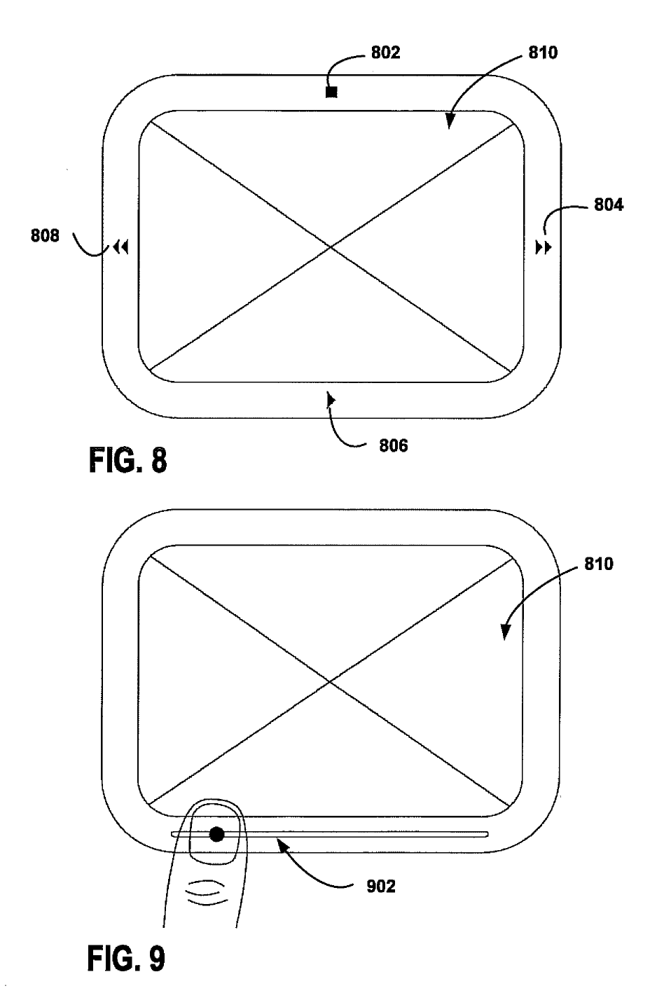

FIG. 9 is an illustration of a front view of the portable communication device in a play mode. The portable communication device 100 may enter the play mode in response to the user tapping the “play” control icon 806 during the video mode as well as in other states. During the play mode, the secondary display 104 includes one or more play mode control icons 902 that facilitate control of the playing video 810 in the primary display. For the example, the secondary display includes a “scrubber” control icon 902 allowing the user to control the start location, speed, and direction of the video play. Examples of other control icons include icons representing “fast forward” and “reverse”.

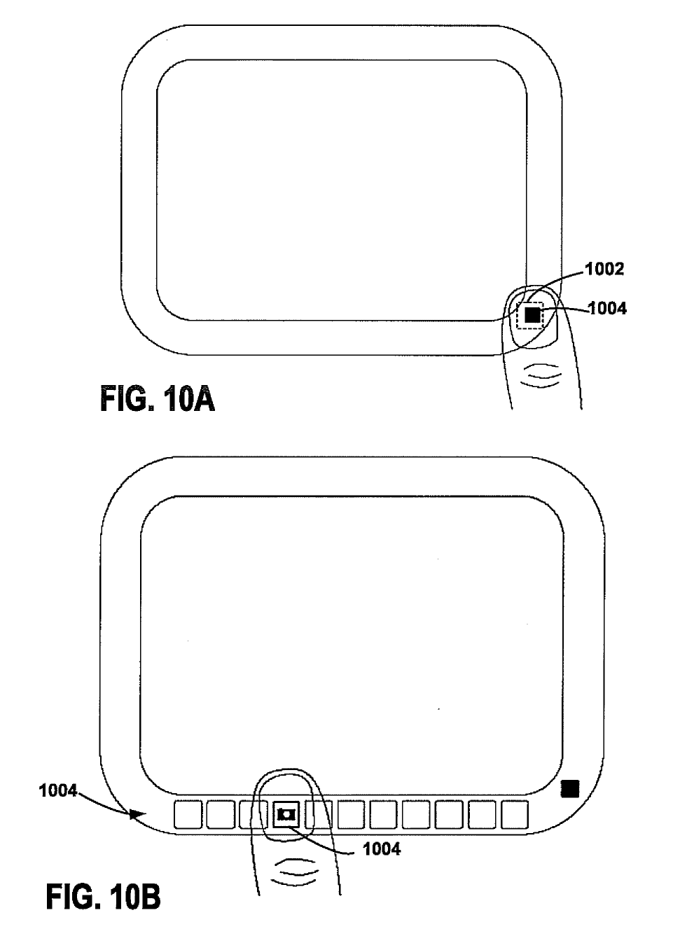

FIG. 10A is an illustration of a front view of the portable communication device during an “all application” selection. An area 1002 on the secondary display is dedicated to the “all applications” input control. In most circumstances, all modes and operational states of the portable communication device include the “all applications” input on the secondary display 102. For the example, the dedicated area 1002 is the lower right corner of the secondary display 102. In some circumstances, a control icon 1004 is displayed in the dedicated area 1002. When the area 1002 is tapped, a plurality of applications icons are displayed on the secondary display.

FIG. 10B is an illustration of a front view of the portable communication device after the “all application” selection is made. FIG. 10B, therefore, shows an example of the displays resulting from the selection of the all applications of FIG. 10A. A plurality of application icons 1006 is presented in the secondary display 104 where each application icon represents an application. The application represented may include all of the applications available or may be a preselected subset of all of the applications. For the example of FIG. 10B, the user is selecting the camera application by tapping the camera application selection icon 1008.

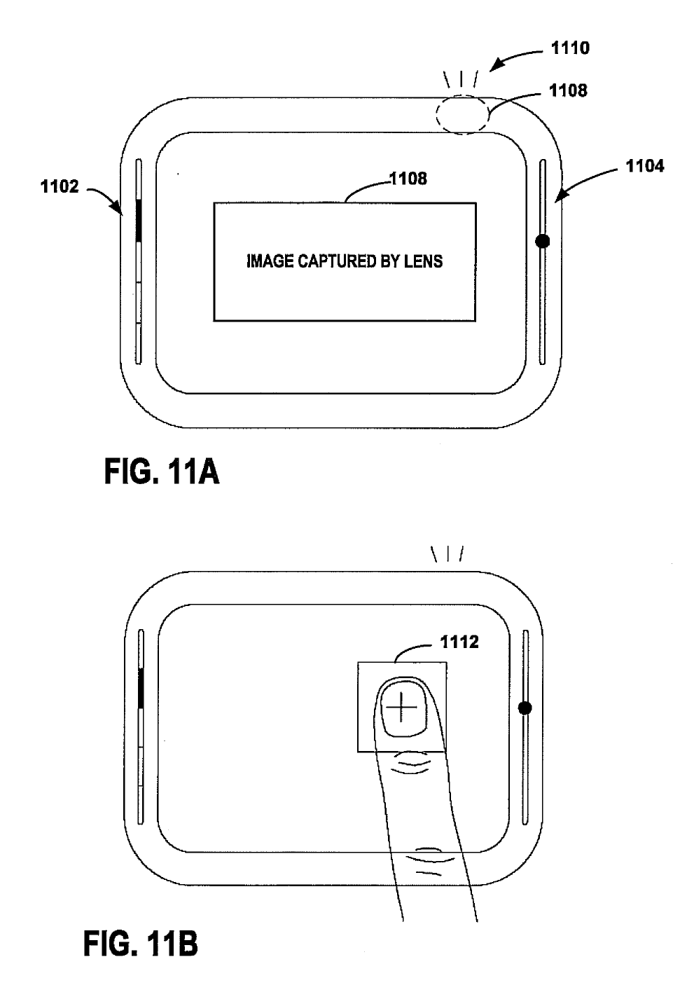

FIG. 11A is an illustration of a front view of the portable communication device 100 during a camera mode. In the camera mode, the secondary display 104 includes camera control icons 1102, 1104 and the primary display 102 includes an image 1106 captured by the camera lens. A lens selection control input is provided with a lens selection icon 1102. The user selects a preferred lens type from a plurality of lens types by tapping the appropriate portion of the lens selection icon 1102. For example, the user can select a lens type from standard, telephoto, macro, wide angle and fisheye lens configurations by tapping the portion of the icon 1102 that corresponds to the desired lens. A zoom control input is provided with a zoom icon 1104. The user slides or taps the icon to vary zoom.

The illumination device 112 illuminates a portion 1108 of the secondary display to represent the “take picture” input 1110. The user takes a picture by tapping the illuminated portion 1108 of the secondary display 104.

FIG. 11B is an illustration of a front view of the portable communication device 100 during a focal point selection. In this mode, the desired focal point of the picture to be taken is selected by touching a location 1112 on a portion of the image 1106 presented on the primary display 102.

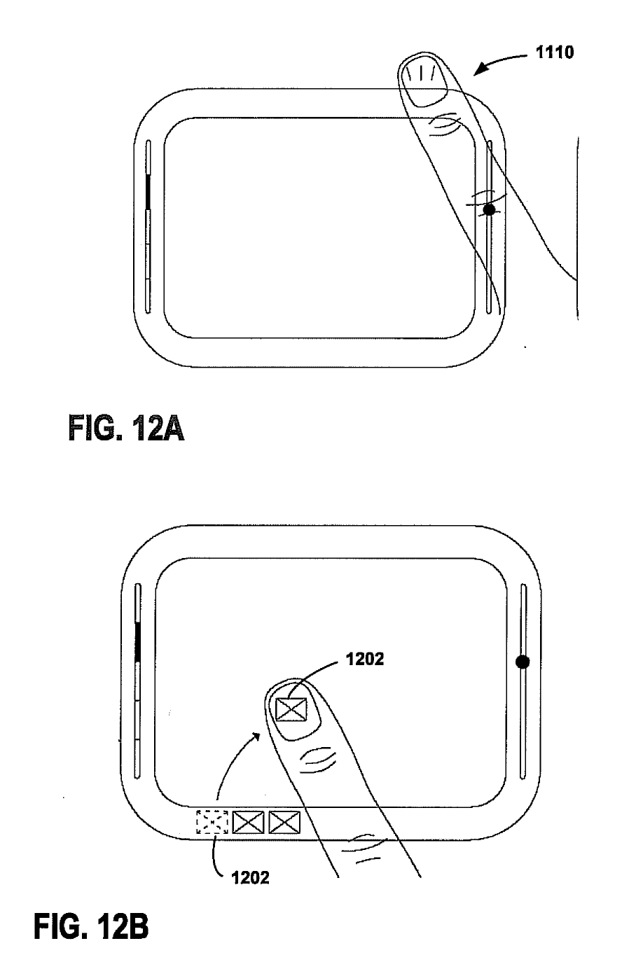

FIG. 12A is an illustration of a front view of the portable communication device during a “take picture” input in the camera mode. As discussed above, the illumination device illuminates a portion of the secondary display to represent the “take picture” input 1110. The user takes a picture by tapping the illuminated portion 1108 of the secondary display 104.

FIG. 12B is an illustration of a front view of the portable communication device during a picture management mode. As pictures are taken, each image is represented by a picture icon 1202 in the secondary display. To display an image in the primary display 102, the user flicks, drags, or swipes the desired picture icon 1202 of the selected image into the primary display 102. Accordingly, the user action of touching the secondary display in motion toward the primary display is interpreted by the controller 106 as an input to “move” the icon to the primary display 102. In response, the controller presents the content represented by the icon 1202 in the primary display 102.

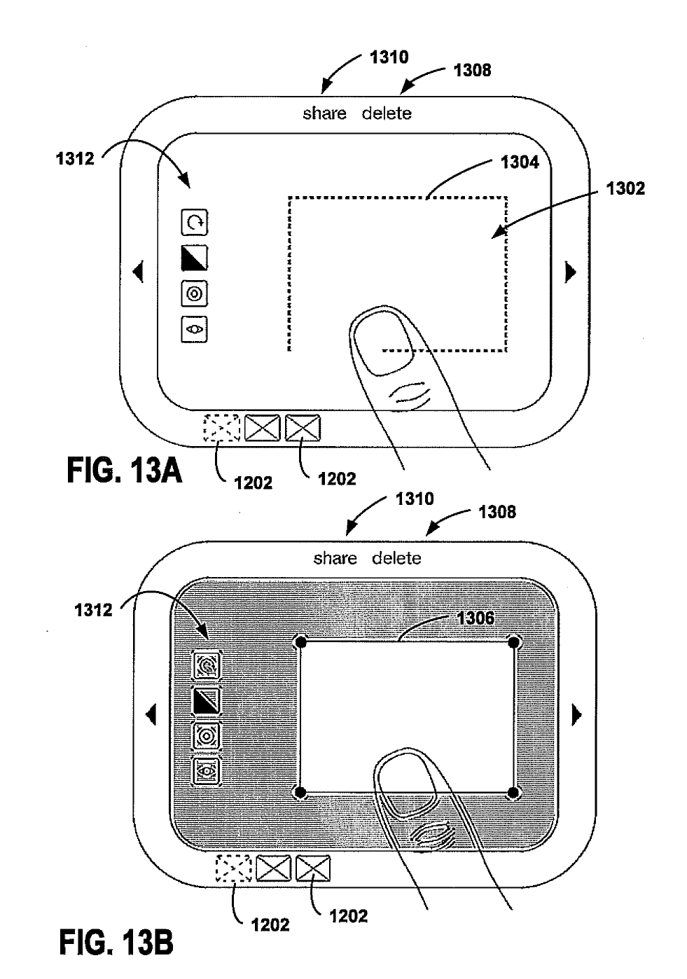

FIG. 13A and FIG. 13B are illustrations of front views of the portable communication device 100 during a first stage and second stage of a picture cropping user input, respectively. The user defines a cropping area 1302 by drawing a perimeter 1304 of the area 1302 to be cropped. The selection is presented by displaying a crop box 1306 around the area 1302. Picture management inputs 1308, 1310, 1312 are presented in the primary display 102 and in the secondary display 104. For the example, a share control input 1310 and a delete control input 1308 are presented in the secondary display 102. In addition, the picture icons 1202 are maintained in the secondary display.

FIG. 13B is an illustration of a front view of the portable communication device during a second stage of a picture cropping user input. When the crop box 1306 is presented, the user can move the box 1306 to a different area by dragging the crop box 1306 within the image in the primary display 102. The size of the box 1306 is modified by dragging one or more corners of the crop box 1306. Double tapping within the crop box 1306 confirms the cropping and completes the action.

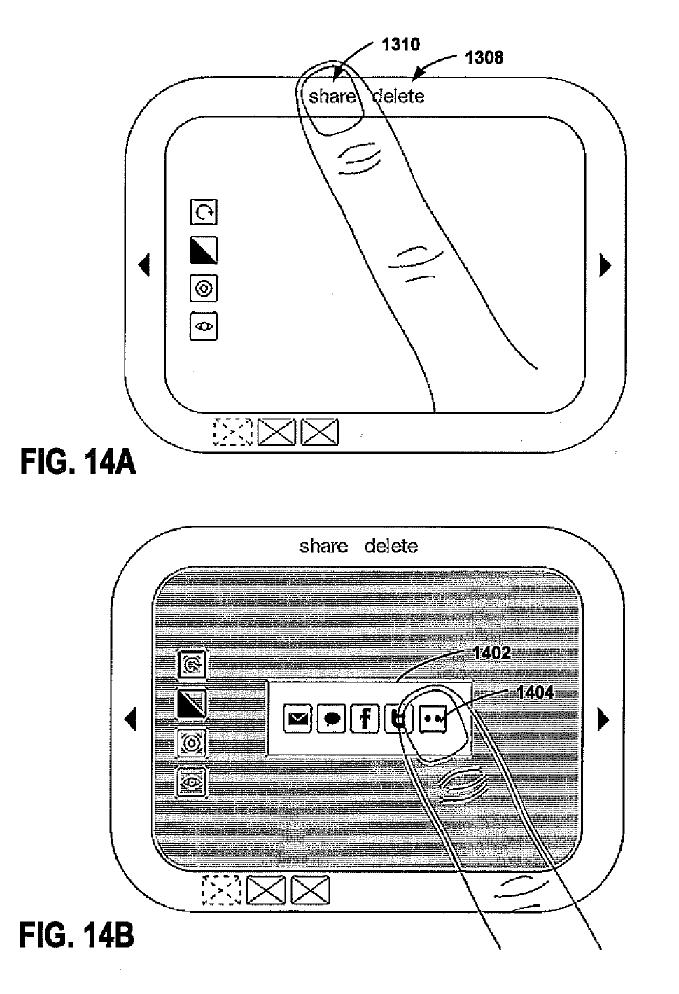

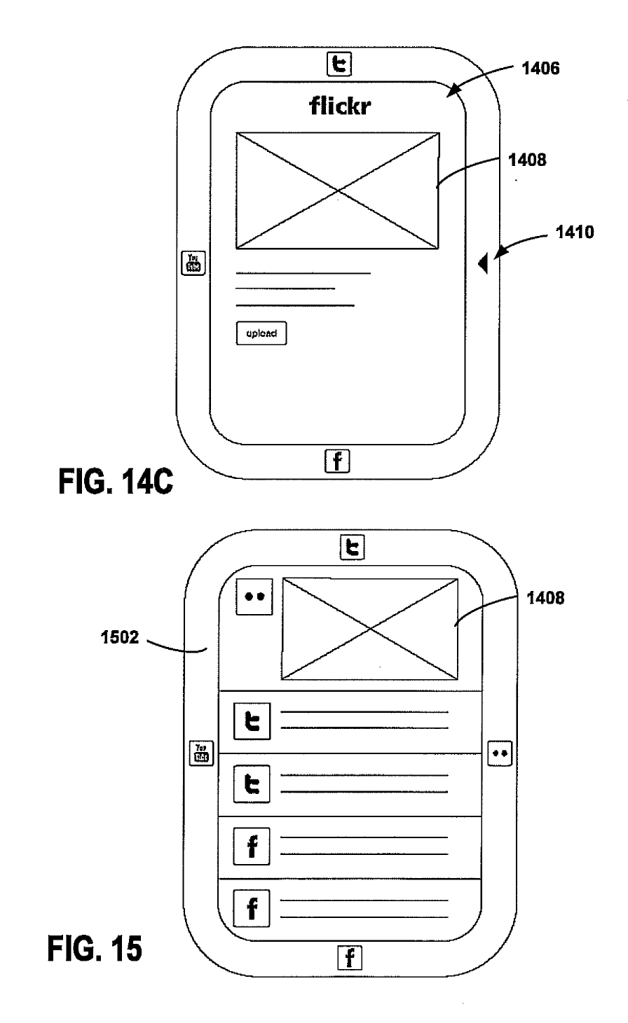

FIG. 14A is an illustration of a front view of the portable communication device during a first stage of a picture sharing procedure. Tapping the share control input 1310 in the secondary display initiates the picture sharing procedure.

FIG. 14B is an illustration of a front view of the portable communication device during a second stage of a picture sharing procedure. In response to the user input selecting the share control input 1310, an application control bar 1402 is presented in the primary display 102. The application control bar 1402 includes an icon representing each application that can be used to share the picture. The applications may include email, instant messaging such as aim, and any number of social networking applications. The user selects the preferred application by tapping on the icon representing the application. For this example, the flickr application is selected by tapping the flickr icon 1404.

FIG. 14C is an illustration of a front view of the portable communication device during a third stage of a picture sharing procedure mode. In response to the selection of the application, the application launches the appropriate uploading or message page 1406. For this example, the flickr upload page is launched allowing the addition to and modification of the picture 1408 to be uploaded. A title and description can be added before the picture 1408 is uploaded. To return to the social networking set of applications, the social networking icon 1410 in the secondary display 102 is tapped by the user.

FIG. 15 is an illustration of a front view of the portable communication device in the application selection mode. In response to the social networking selection, the portable communication device 100 returns to the social networking application selection node. The flickr entry 1502 of the uploaded picture 1408 is displayed in the list of social networking entries 1504.

Accordingly, content within the primary display is managed by accessing a control inputs on the secondary display. As described above, numerous management functions can be performed such as launching applications, editing multi-media objects, sending messages, and sharing content as well as other functions. User input is provided by changing the orientation of the device 100 to position a desired selection at the top of the secondary display.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A portable communication device comprising:
a primary display having a perimeter;
a secondary display positioned adjacent to most of the perimeter.

2. The portable communication device of claim 1, wherein the secondary display is translucent.

3. The portable communication device of claim 1, wherein the secondary display surrounds the primary display.

4. The portable communication device of claim 1, wherein the secondary display includes an interface icon for managing content shown in the primary display.

5. The portable communication device of claim 4, wherein the secondary display comprises a clear liquid crystal display (LCD) responsive to control signals to generate the interface icon.

6. The portable communication device of claim 5, wherein the LCD is responsive to control signals to generate a first set of interface icons for a first mode and a second set of interface icons for a second mode.

7. The portable communication device of claim 6, wherein the secondary display comprises a plurality of capacitor sensors configured to generate user input signals in response to user interaction with the secondary display.

8. The portable communication device of claim 7, wherein the user interaction comprises tapping, touching, dragging, and combinations thereof.

9. A portable communication device of claim 4, wherein the interface icon for managing content shown in the primary display is a control input for launching an application.

10. A portable communication device of claim 4, wherein the interface icon for managing content shown in the primary display is a control input for editing multi-media content displayed in the primary display.

11. A portable communication device of claim 4, wherein the interface icon for managing content shown in the primary display is a control input for sending a message.

12. A portable communication device of claim 4, wherein the interface icon for managing content shown in the primary display is a control input for uploading the content to a website server.

13. The portable communication device of claim 1, further comprising an illumination device configured to illuminate the secondary display.

14. The portable communication device of claim 1, wherein the illumination device is configured to illuminate the secondary display with a first color when the portable communication device is in a first state of and in a second color when the portable communication device is in a second state.

15. The portable communication device of claim 1, further comprising an orientation detector and a controller configured to identify a user selection of an application represented in a portion of the secondary display positioned to be at a top portion of the secondary display.

16. The portable communication device of claim 1, further comprising an orientation detector and a controller configured to identify a user selection of a function represented in a portion of the secondary display positioned to be at a top portion of the secondary display.

17. A portable communication device comprising:
a primary display; and
a translucent secondary display surrounding the primary display and comprising:
a clear liquid crystal display (LCD) configured to present images on the secondary display in response to control signals from the controller; and
a plurality of capacitive sensors configured to generate user input control signals in response to physical interaction with the secondary display.

18. The portable communication device of claim 17, wherein the clear LCD is configured to present an icon and wherein physical interface with an area of the secondary display including the icon allows management of content displayed in the primary display.

19. A portable communication device comprising:
a display having at least two portions;
a orientation detector configured to generate a control signal indicating an orientation of the portable communication device relative to ground and to indicate one of the portions of the at least two portions as being a top portion further from the ground then other portions of the at least two portions; and
a controller configured to interpret a user selection of an icon displayed in the top portion.

20. The portable communication device of claim 19, wherein the display is a translucent display comprising:
a clear liquid crystal display (LCD) configured to present images on the translucent display in response to control signals from the controller; and
a plurality of capacitive sensors configured to generate user input control signals in response to physical interaction with the translucent display.

21. The portable communication device of claim 19, wherein the display is a translucent display comprising:
a dot matrix system configured to present images on the translucent display in response to control signals from the controller;
and a plurality of capacitive sensors configured to generate user input control signals in response to physical interaction with the translucent display.
